(19) United States
(12) Patent Application Publication
(10) Pub. No.: US 2021/0329845 A1
(43) Pub. Date: Oct. 28, 2021

(54) BLADE-HEATABLE ELECTRIC SCISSORS AND CONTROL METHOD

(71) Applicant: Dongguan Zhenghong Technology Service Co., Ltd., Dongguan (CN)

(72) Inventor: Xianpeng Ma, Dongguan (CN)

(73) Assignee: Dongguan Zhenghong Technology Service Co., Ltd.

(21) Appl. No.: 17/371,141

(22) Filed: Jul. 9, 2021

(30) Foreign Application Priority Data
Aug. 10, 2020 (CN) 202010797280.9

(51) Int. Cl. A01G 3/025; B26D 7/10

(52) U.S. Cl. CPC A01G 3/0255; B26D 2007/0025; B26D 7/10

(57) ABSTRACT

The present invention discloses blade-heatable electric scissors and a control method. The electric scissors include a scissors main body. A first blade is arranged at a front end of the scissors main body; a heating sheet and a temperature sensor are arranged on the first blade, and the heating sheet and the temperature sensor are connected to a heating sheet drive circuit and a blade temperature detection circuit through a conduction cable respectively. Compared with the prior art, the present invention arranges the heating sheet on the shearing blade so that a cut can be subjected to high-temperature disinfection while a branch is pruned.

### FIELD

The present invention relates to a gardening tool, in particular to an electric scissors technology, specifically to blade-heatable electric scissors and a control method.

### BACKGROUND

Through reasonable pruning of branches of trees, over-vigorous growth of plants can be inhibited, and tree vigor is balanced. Heavily pruning aged trees may achieve the effects of regeneration and rejuvenation, so that the plants may restore vigorous vitality, a life span of the plants is prolonged, and long-term and stable landscape effects are maintained; and a relationship between growth and fruiting is adjusted to enhance the ornamental effect of flowers and fruits. Growth is a basis of fruiting of flowering and fruiting type ornamental plants, and fruiting also influences the growth of trees in turn.

Wounds left on pruned branches need to be disinfected by applying a healing agent so that the trees are prevented from being infected with bacteria and getting rotten. However, the healing agent needs to be applied on the wounds one by one, which is time-wasting and laborious and severely influences the pruning efficiency. Therefore, it is necessary to develop a high-temperature disinfection method and tool with a disinfection-upon-pruning function to improve the cutting efficiency.

After inquiry, no relevant reports have been found.

### SUMMARY

An objective of the present invention is to overcome the problem that in the prior art, wounds left on pruned branches need to be disinfected by applying a healing agent so that trees are prevented from being infected with bacteria and getting rotten, but the healing agent needs to be applied on the wounds one by one, which is time-wasting and laborious and severely influences the pruning efficiency, and to provide blade-heatable electric scissors and a control method. A blade is heated to a sufficiently-high temperature upon cutting to realize disinfection upon pruning to improve the cutting and disinfection efficiency

In order to achieve the above objective, the present invention provides the following technical solution:

the blade-heatable electric scissors are designed and manufactured. The electric scissors include a scissors main body. A first blade is arranged at a front end of the scissors main body, and a heating sheet and a temperature sensor are arranged on the first blade; the heating sheet and the temperature sensor are connected to a heating sheet drive circuit and a blade temperature detection circuit through a conduction cable respectively, and a drive end PWM1H of the heating sheet drive circuit is connected to one pin of a single chip microcomputer U1; and an output end TEM of the blade temperature detection circuit is connected to another pin of the single chip microcomputer U1.

Two leads in the conduction cable are connected to two electrodes of the temperature sensor; one, connected to an upper end of the temperature sensor, of the leads is finally connected to a resistor R6, and a junction serves the output end TEM of the blade temperature detection circuit; and the other one, connected to a lower end of the temperature sensor, of the leads is finally connected to a ground wire of the blade temperature detection circuit.

The two leads in the conduction cable are connected to two electrodes of the heating sheet; one, connected to an upper end of the heating sheet, of the leads is finally connected to VCC of a power circuit, and the other one, connected to a lower end of the heating sheet, of the leads is finally connected to a drain of a field effect transistor Q1 in the heating sheet drive circuit.

The front end of the scissors main body is provided with an indicator light; and the indicator light is connected to one output pin of the single chip microcomputer U1 through a resistor R9.

One input pin of the single chip microcomputer U1 is connected to a potentiometer VER1 in a blade heating temperature adjustment circuit.

A control method of the blade-heatable electric scissors is implemented. The control method includes the following steps:

step I, firstly, arranging a heating sheet and a temperature sensor on a first blade, rotating around a scissors shaft, at a front end of a scissors main body of the electric scissors; embedding the heating sheet tightly into a blade body of the first blade; arranging the temperature sensor near the heating sheet so as to be tightly attached to the blade body;

arranging a power circuit, wherein the power circuit provides three types of power for the electric scissors: a first type is DC3V or DC5V power for operation of a single chip microcomputer U1, a blade heating temperature adjustment circuit, a heating sheet drive circuit and a blade temperature detection circuit, a second type is DC12V power for operation of a cutting electric motor in the scissors main body; and a third type is a VCC of DC28-60V power for operation of the heating sheet;

step II, arranging a single chip microcomputer U1, and loading a startup preheating program module, a blade temperature detection program module, a cutting time setting program module, a PWM drive program module, an operation state indicator light program module, a temperature over-limit alarm program module, a reference temperature correction program module and a cutting early-heating program module in a program memory of the single chip microcomputer U1, wherein each program module may be loaded and run by a processor;

step III, then connecting the heating sheet and the temperature sensor to a heating sheet drive circuit and a blade temperature detection circuit through a conduction cable respectively, wherein a drive end PWM1H of the heating sheet drive circuit is connected to one output pin of the single chip microcomputer U1, and and an output end TEM of the blade temperature detection circuit is connected to one input pin of the single chip microcomputer U1;

step IV, next arranging a blade heating temperature adjustment circuit, wherein a slide point of a potentiometer VER1 in the circuit is connected to one input pin of the single chip microcomputer U1;

step V, switching on a startup switch on the scissors main body when cutting is ready to start, running the startup preheating program module, the blade temperature detection program module, the cutting time setting program module and the operation state indicator light program module by the single chip microcomputer U1, at this moment, heating the first blade to a preheated state, detecting a preheated temperature by the blade temperature detection program module, and determining whether cutting may be performed according to an illumination state of the indicator light;

step VI, pulling a trigger during cutting to trigger a first pin ED of the single chip microcomputer U1, running the cutting early-heating program module by the single chip microcomputer U1 to rapidly heat the first blade to a cutting high temperature state, ejecting a cutting drive rod under drive of the cutting electric motor according to control of the cutting time setting program module, driving the first blade to perform cutting by a shearing drive shaft, and after cutting is completed, stopping the cutting high temperature state of the first blade by the cutting time setting program module and returning to the preheated state;

step VII, when a reference of the preheated state and a reference of the cutting high temperature state need to be adjusted in a use process due to a geographic latitude difference, an environment temperature difference and a cut material difference, rotating the potentiometer VER1 in the blade heating temperature adjustment circuit, running the reference temperature correction program module, and raising or lowering the reference; and

step VIII, if a heating temperature exceeds a maximum limit in the use process, turning on the indicator light by the temperature over-limit alarm program module to rapidly flash, and stopping the operation of the electric scissors.

A drive end PWM1H of the heating sheet drive circuit is connected to one output pin of the single chip microcomputer U1; the pin outputs a PWM drive waveform generated by the PWM drive program module; the waveform varies in duty ratio; a field effect transistor Q1 varies in conduction degree; and the heating sheet varies in heated degree.

An output end TEM of the blade temperature detection circuit is connected to one input pin of the single chip microcomputer U1; the pin inputs a voltage induced by an upper end of the temperature sensor; the first blade varies in temperature, and the voltage induced by the upper end of the temperature sensor varies accordingly; and the voltage is converted into a digital signal through an A/D converter inside the pin and the blade temperature detection program module for control.

The blade heating temperature adjustment circuit is connected to one input pin of the single chip microcomputer U1, and the pin inputs a potential of a midpoint of the potentiometer VER1; the potential is converted into a digital signal through the A/D converter inside the pin and the reference temperature correction program module for reference temperature adjustment.

When the voltage VCC of the DC28-60V power for the operation of the heating sheet varies, and the preheated temperature is set during initial starting, the voltage VCC of the power may be indirectly detected through the startup preheating program module and the blade temperature detection program module; and the PWM drive program module is started to correct a duty ratio of a PWM signal.

Compared with the prior art, the present invention arranges the heating sheet on the cutting blade so that a cut may be subjected to high-temperature disinfection while a branch is pruned. Meanwhile, the present invention may adjust a preheated temperature reference and a cutting high temperature reference according to a latitude difference, an environment temperature difference, and a variety difference of cut plants. According to the present invention, the blade is further set to be heated to a high temperature upon cutting, thereby greatly saving electric energy; and disinfection and sterilization operation on the cut is completed as well while a cutting action is completed by the present invention, thereby greatly improving efficiency.

### BRIEF DESCRIPTION OF THE DRAWINGS

FIG. 1 is a schematic overall structural diagram of a first implementation mode of blade-heatable electric scissors and a control method of the present invention;

FIG. 2 is a schematic diagram during branch cutting by a heating blade according to the blade-heatable electric scissors and the control method of the present invention;

FIG. 3 is a schematic circuit diagram of a control circuit according to the blade-heatable electric scissors and the control method of the present invention; and

FIG. 4 is a block diagram of a program module loaded in a program memory in a single chip microcomputer U1 in the blade-heatable electric scissors and the control method of the present invention.

### DETAILED DESCRIPTION OF THE EMBODIMENTS

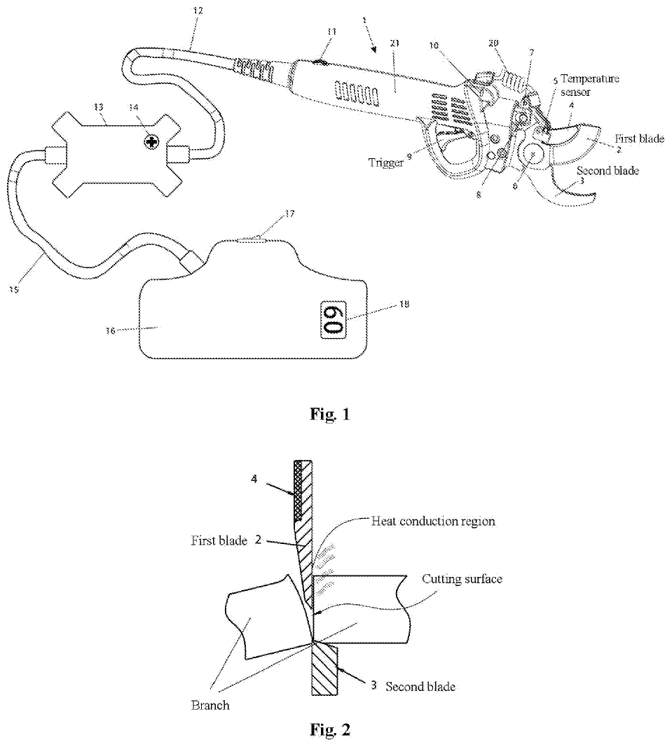

As shown in FIG. 1, a first embodiment of the present invention shows a separable form of an electric scissors main body 21, a controller 13 and a battery 16. The electric scissors main body 21 is connected to the controller 13 through a control cable 12, and the controller 13 is connected to the battery 16 through a power cable 15.

In a second embodiment of the present invention, a body and a controller are combined into a whole, and the battery is separated. In the present embodiment, part of contents of the controller is transferred into the electric scissors main body 21 so that the volume of the electric scissors main body 21 is slightly greater than that in the first embodiment, but use is not affected though.

In a third embodiment, a power cable may be connected to rectification power as long as the mains supply available for power can be connected or the power cable is long enough.

The technical solutions of the present invention will be described below clearly and comprehensively in conjunction with the accompanying drawings in the first embodiment of the present invention. Apparently, embodiments described are merely some of, rather than all of, the embodiments of the present invention. Based on the embodiments of the present invention, all the other embodiments obtained by those of ordinary skill in the art without making creative efforts fall within the scope of protection of the present invention.

FIGS. 1 to 4 show a first embodiment of the present invention:

Blade-heatable electric scissors 1 include a scissors main body 21. A first blade 2 is arranged at a front end of the scissors main body 21, and a heating sheet 4 and a temperature sensor 5 are arranged on the first blade 2; the heating sheet 4 and the temperature sensor 5 are connected to a heating sheet drive circuit and a blade temperature detection circuit through a conduction cable 20 respectively; a drive end PWM1H of the heating sheet drive circuit is connected to one pin of a single chip microcomputer U1; and an output end TEM of the blade temperature detection circuit is connected to another pin of the single chip microcomputer U1.

Two leads in the conduction cable 20 are connected to two electrodes of the temperature sensor 5; one, connected to an upper end of the temperature sensor 5, of the leads is finally connected to a resistor R6, and a junction serves as the output end TEM of the blade temperature detection circuit; and the other one, connected to a lower end of the temperature sensor 5, of the leads is finally connected to a ground wire of the blade temperature detection circuit.

The two leads in the conduction cable 20 are connected to two electrodes of the heating sheet 4; one, connected to an upper end of the heating sheet 4, of the leads is finally connected to VCC of a power circuit; and the other one, connected to a lower end of the heating sheet 4, of the leads is finally connected to a drain of a field effect transistor Q1 in the heating sheet drive circuit.

A front end of the scissors main body 21 is provided with an indicator light 10, and the indicator light 10 is connected to one output pin of the single chip microcomputer U1 through a resistor R9.

One input pin of the single chip microcomputer U1 is connected to a potentiometer VER1 in a blade heating temperature adjustment circuit.

A control method of the blade-heatable electric scissors includes the following steps:

step I, firstly, arranging a heating sheet 4 and a temperature sensor 5 on a first blade 2, rotating around a scissors shaft 6, at a front end of a scissors main body 21 of the electric scissors 1; embedding the heating sheet 4 tightly into a blade body of the first blade 2; arranging the temperature sensor 5 near the heating sheet 4 so as to be tightly attached to the blade body; and

arranging a power circuit, wherein the power circuit provides three types of power for the electric scissors: a first type is DC3V or DC5V power for operation of a single chip microcomputer U1, a blade heating temperature adjustment circuit, a heating sheet drive circuit and a blade temperature detection circuit; a second type is DC12V power for operation of a cutting electric motor in the scissors main body 21; and a third type is VCC of DC28-60V power for operation of the heating sheet 4;

step II, arranging a single chip microcomputer U1, and loading a startup preheating program module 101, a blade temperature detection program module 102, a cutting time setting program module 103, a PWM drive program module 104, an operation state indicator light program module 105, a temperature over-limit alarm program module 106, a reference temperature correction program module 107 and a cutting early-heating program module 108 in a program memory 100 of the single chip microcomputer U1, wherein each program module may be loaded and run by a processor 110;

step III, then connecting the heating sheet 4 and the temperature sensor 5 to the heating sheet drive circuit and the blade temperature detection circuit through a conduction cable 20 respectively, wherein a drive end PWM1H of the heating sheet drive circuit is connected to one output pin of the single chip microcomputer U1, and an output end TEM of the blade temperature detection circuit is connected to one input pin of the single chip microcomputer U1;

step IV, next arranging a blade heating temperature adjustment circuit, wherein a slide point of a potentiometer VER1 in the circuit is connected to one input pin of the single chip microcomputer U1;

step V, switching on a startup switch 11 on the scissors main body 21 when cutting is ready to start, running the startup preheating program module 101, the blade temperature detection program module 102, the cutting time setting program module 103 and the operation state indicator light program module 105 by the single chip microcomputer U1, at this moment, heating the first blade 2 to a preheated state, detecting a preheated temperature by the blade temperature detection program module 102, and determining whether cutting may be performed according to an illumination state of the indicator light 10;

step VI, pulling a trigger 9 when cutting is performed to trigger a first pin ED of the single chip microcomputer U1, running the cutting early-heating program module 108 by the single chip microcomputer U1, rapidly heating the first blade 2 to a cutting high temperature state, ejecting a cutting drive rod 7 under drive of the shearing electric motor according to control of the cutting time setting program module 103, driving the first blade 2 to perform cutting by a cutting drive shaft 8, and after cutting is completed, stopping the cutting high temperature state of the first blade 2 by the cutting time setting program module 103, and returning to the preheated state;

step VII, when a reference of the preheated state and a reference of the cutting high temperature state need to be adjusted in a use process due to a geographic latitude difference, an environment temperature difference and a sheared material difference, rotating the potentiometer VER1 in the blade heating temperature adjustment circuit, running the reference temperature correction program module 107, and raising or lowering the reference; and

step VIII, if a heating temperature exceeds a maximum limit during use, turning on the indicator light 10 by the temperature over-limit alarm program module 106 to rapidly flash, and stopping the operation of the electric scissors.

In the above method, the drive end PWM1H of the heating sheet drive circuit is connected to one output pin of the single chip microcomputer U1, and the pin outputs a PWM drive waveform generated by the PWM drive program module 104; the waveform varies in duty ratio, a field effect transistor Q1 varies in conduction degree accordingly, and the heating sheet 4 varies in heated degree.

In the above method, the output end TEM of the blade temperature detection circuit is connected to one input pin of the single chip microcomputer U1, and the pin inputs a voltage induced by an upper end of the temperature sensor 5; the first blade 2 varies in temperature, and the voltage induced by the upper end of the temperature sensor 5 varies accordingly; the voltage is converted into a digital signal through an A/D converter inside the pin and the blade temperature detection program module 102 for control.

In the above method, the blade heating temperature adjustment circuit is connected to one input pin of the single chip microcomputer U1, and the pin inputs a potential of a midpoint of the potentiometer VER1; the potential is converted into a digital signal through the A/D converter inside the pin and the reference temperature correction program module 107 for reference temperature adjustment.

In the above method, when the voltage VCC of the DC28-60V power for the operation of the heating sheet 4 varies, and the preheated temperature is set during initial starting, the voltage VCC of the power may be indirectly detected through the startup preheating program module 101 and the blade temperature detection program module 102; and the PWM drive program module 104 is started to correct a duty ratio of a PWM signal.

As shown in FIG. 2, a second blade 3 is stationary, and the first blade 2 moves from top to bottom to cut a branch shown in FIG. 2. In a cutting process, a branch on the right side in the figure is to be preserved; a cut is ironed by a heat conduction region of the first blade 2 and is disinfected and sterilized, so that it is necessary to pay attention to a direction of cutting when the scissors of the present invention are used.

When the first embodiment of the present invention is used, a power switch 17 on the battery 16 is switched on at first to power up the controller 13; the startup switch 11 on the electric scissors main body 21 is switched on, and the electric scissors 1 enter into an operation preparing state. A user observes the illumination state of the indicator light 10, and may perform cutting and high temperature disinfection and sterilization operation when confirming that the electric scissors 1 get ready. Two functions are completed in one operation process, thereby greatly improving efficiency.

In the first embodiment, a battery capacity indication window 18 is arranged on the battery 16, on which remaining battery capacity is displayed.

Since the geographic latitude and the environment temperature are different, a temperature reference of the preheated state is selected from 70° C. to 90° C., and a temperature reference of the cutting high temperature state is selected from 120° C. to 150° C. The user may determine optimal reference parameters only through two trials.

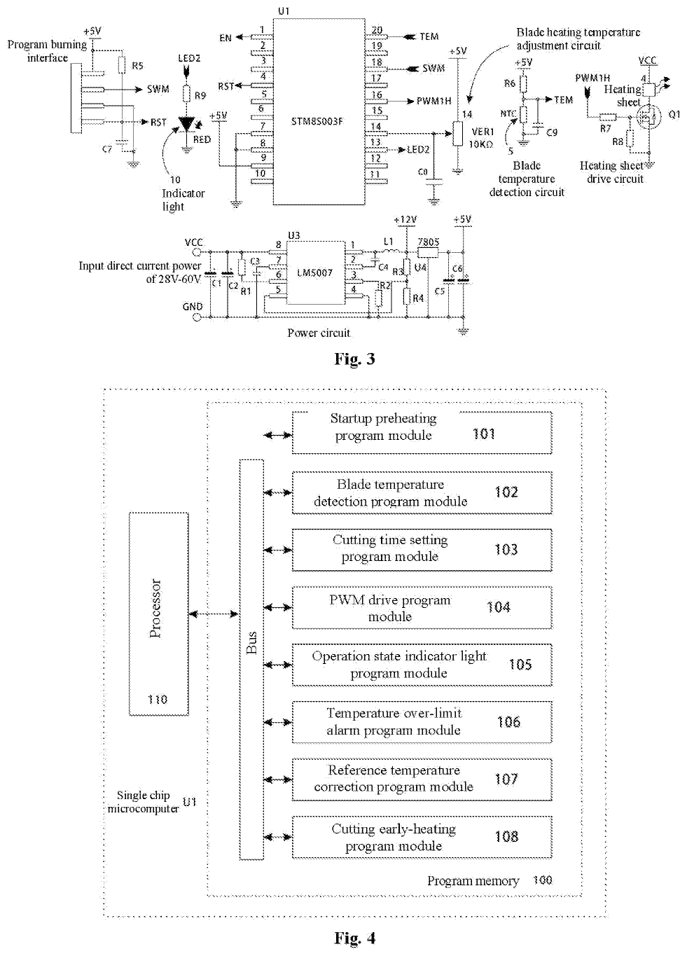

A high temperature over-limit threshold is selected from 200° C. to 250° C. The parameters above are pre-written into the program module, and the user rotates the VER1 to change an input level of a 14th pin of the single chip microcomputer U1 in FIG. 3; and a digital voltage after A/D conversion is read by the reference temperature correction program module 107 to determine a new temperature reference.

STM8S003F is selected for the single chip microcomputer U1 in FIG. 3, and there are many single chip microcomputers to replace this model, which have a similar price and basically identical functional parameters, for example, STC15W408S, and are not enumerated here.

For those skilled in the art, it is apparent that the present invention is not limited to the details of the above-mentioned exemplary embodiments, and the present invention can be implemented in other specific forms without departing from the spirit or basic features of the present invention. Therefore, no matter from which point of view, the embodiments should all be regarded as exemplary and non-limiting. The scope of the present invention is defined by the appended claims rather than the above-mentioned description, and therefore it is intended that all changes which fall within the meaning and scope of equivalent elements of the claims are embraced in the present invention. Any reference sign in the claims should not be construed as limiting the related claims.

What is claimed is:

1. Blade-heatable electric scissors, characterized in that the electric scissors (1) comprise a scissors main body (21); a first blade (2) is arranged at a front end of the scissors main body (21), and a heating sheet (4) and a temperature sensor (5) are arranged at the first blade (2); the heating sheet (4) and the temperature sensor (5) are connected to a heating sheet drive circuit and a blade temperature detection circuit through a conduction cable (20) respectively; a drive end PWM1H of the heating sheet drive circuit is connected to one pin of a single chip microcomputer U1; and an output end TEM of the blade temperature detection circuit is connected to another pin of the single chip microcomputer U1.

2. The blade-heatable electric scissors according to claim 1, characterized in that two leads in the conduction cable (20) are connected to two electrodes of the temperature sensor (5); one, connected to an upper end of the temperature sensor (5), of the leads is finally connected to a resistor R6, and a junction serves as the output end TEM of the blade temperature detection circuit; and the other one, connected to a lower end of the temperature sensor (5), of the leads is finally connected to a ground wire of the blade temperature detection circuit.

3. The blade-heatable electric scissors according to claim 1, characterized in that two leads in the conduction cable (20) are connected to two electrodes of the heating sheet ( ); one, connected to an upper end of the heating sheet (4), of the leads is finally connected to a voltage of the common collector (VCC) of a power circuit; and the other one, connected to a lower end of the heating sheet (4), of the leads is finally connected to a drain of a field effect transistor Q1 in the heating sheet drive circuit.

4. The blade-heatable electric scissors according to claim 1, characterized in that an indicator light (10) is arranged at the front end of the scissors main body (21), and the indicator light (10) is connected to one output pin of the single chip microcomputer U1 through a resistor R9.

5. The blade-heatable electric scissors according to claim 1, characterized in that one input pin of the single chip microcomputer U1 is connected to a potentiometer VER1 in a blade heating temperature adjustment circuit.

6. A control method for blade-heatable electric scissors, characterized in that the control method comprises the following steps:
step I, firstly, arranging a heating sheet (4) and a temperature sensor (5) on a first blade (2), rotating around a scissors shaft (6), at a front end of a scissors main body (21) of the electric scissors (1); embedding the heating sheet (4) tightly into a blade body of the first blade (2); arranging the temperature sensor (5) near the heating sheet (4) so as to be tightly attached to the blade body;
arranging a power circuit, wherein the power circuit provides three types of power for the electric scissors: a first type of power is DC3V or DC5V power for operation of a single chip microcomputer U1, a blade heating temperature adjustment circuit, a heating sheet drive circuit and a blade temperature detection circuit, a second type of power is DC12V power for operation of a cutting electric motor in the scissors main body (21), and a third type of power is DC28-60V power VCC for operation of the heating sheet (4);
step II, arranging a single chip microcomputer U1, and loading a startup preheating program module (101), a blade temperature detection program module (102), a cutting time setting program module (103), a PWM drive program module (104), an operation state indicator light program module (105), a temperature over-limit alarm program module (106), a reference temperature correction program module (107) and a cutting early-heating program module (108) in a program memory (100) of the single chip microcomputer U1, wherein each program module may be loaded and run by a processor (110);
step III, then connecting the heating sheet (4) and the temperature sensor (5) to the heating sheet drive circuit and the blade temperature detection circuit through a conduction cable (20) respectively, wherein a drive end PWM1H of the heating sheet drive circuit is connected to one output pin of the single chip microcomputer U1, and an output end TEM of the blade temperature detection circuit is connected to one input pin of the single chip microcomputer U1;
step IV, next arranging a blade heating temperature adjustment circuit, wherein a slide point of a potentiometer VER1 in the circuit is connected to one input pin of the single chip microcomputer U1;
step V, switching on a startup switch (11) on the scissors main body (21) when cutting is ready to start, running the startup preheating program module (101), the blade temperature detection program module (102), the cutting time setting program module (103) and the operation state indicator light program module (105) by the single chip microcomputer U1, at this moment, heating the first blade (2) to a preheated state, detecting a preheated temperature by the blade temperature detection program module (102), and determining whether cutting may be performed according to an illumination state of the indicator light (10);
step VI, pulling a trigger (9) when cutting is performed to trigger a first pin ED of the single chip microcomputer U1, running the cutting early-heating program module (108) by the single chip microcomputer U1, rapidly heating the first blade (2) to a cutting high temperature state, ejecting a shearing drive rod (7) under drive of the shearing electric motor according to control of the cutting time setting program module (103), driving the first blade (2) to perform cutting by a shearing drive shaft (8), and after cutting is completed, stopping the cutting high temperature state of the first blade (2) by the cutting time setting program module (103) and returning to a preheated state;
step VII, when a reference of the preheated state and a reference of the cutting high temperature state need to be adjusted in a use process due to a geographic latitude difference, an environment temperature difference and a sheared material difference, rotating the potentiometer VER1 in the blade heating temperature adjustment circuit, running the reference temperature correction program module (107), and raising or lowering the reference; and
step VIII, if a heating temperature exceeds a maximum limit during use, turning on the indicator light (10) by the temperature over-limit alarm program module (106) to rapidly flash, and stopping the operation of the electric scissors.

7. The control method for the blade-heatable electric scissors according to claim 6, characterized in that the drive end PWM1H of the heating sheet drive circuit is connected to one output pin of the single chip microcomputer U1, and the pin outputs a PWM drive waveform generated by the PWM drive program module (104); and the waveform varies in duty ratio, a field effect transistor Q1 varies in conduction degree accordingly, and the heating sheet (4) varies in heated degree.

8. The control method for the blade-heatable electric scissors according to claim 6, characterized in that the output end TEM of the blade temperature detection circuit is connected to one input pin of the single chip microcomputer U1, and the pin inputs a voltage induced by an upper end of the temperature sensor (5); the first blade (2) varies in temperature, and the voltage induced by the upper end of the temperature sensor (5) varies accordingly; and the voltage is converted into a digital signal through an A/D converter inside the pin and the blade temperature detection program module (102) for control.

9. The control method for the blade-heatable electric scissors according to claim 6, characterized in that the blade heating temperature adjustment circuit is connected to one input pin of the single chip microcomputer U1, and the pin inputs a potential of a midpoint of the potentiometer VER1; the potential is converted into a digital signal through the A/D converter inside the pin and the reference temperature correction program module (107) for reference temperature adjustment.

10. The control method for the blade-heatable electric scissors according to claim 6, characterized in that when the voltage VCC of the DC28-60V power for the operation of the heating sheet (4) varies, and the preheated temperature is set during initial starting, the voltage VCC of the power may be indirectly detected through the startup preheating program module (101) and the blade temperature detection program module (102); and the PWM drive program module (104) is started to correct a duty ratio of a PWM signal.
